(19) United States
(12) Patent Application Publication
(10) Pub. No.: US 2026/0326635 A1
(43) Pub. Date: Oct. 22, 2026

(54) ADJUSTMENT STRUCTURE, BASE ASSEMBLY, TOP ROD STRUCTURE, AND CHILD SAFETY SEAT

(71) Applicant: WONDERLAND SWITZERLAND AG, Steinhausen (CH)

(72) Inventors: Ganqing FANG, Dongguan, Guangdong (CN); Ruyi LI, Dongguan, Guangdong (CN); Daliang ZHANG, Dongguan, Guangdong (CN)

(73) Assignee: WONDERLAND SWITZERLAND AG, Steinhausen (CH)

(21) Appl. No.: 19/109,446

(22) PCT Filed: Sep. 6, 2023
(86) PCT No.: PCT/EP2023/074384

§ 371 Date: Mar. 6, 2025

(30) Foreign Application Priority Data
Sep. 6, 2022 (CN) 202211084066.4
Mar. 23, 2023 (CN) 202310294530.0

(51) Int. Cl. B60N 2/28

(52) U.S. Cl. CPC B60N 2/2821

(57) ABSTRACT

An adjustment structure of a child safety seat according to the present disclosure includes a housing; an abutting member at least partially disposed in the housing and may move with respect to the housing between a retracted position in which it extends into the housing and an extended position in which it extends out of the housing; an adjusting member coupled with the abutting member and operable to move the abutting member to the extended position; and a locking device coupled with the adjusting member and may lock the abutting member in the extended position. The present disclosure also relates to a base assembly, a top rod structure and a child safety seat.

### TECHNICAL FIELD

The present disclosure relates to an adjustment structure, a base assembly, a top rod structure and a child safety seat.

### BACKGROUND

A child safety seat is a common device installed in a vehicle such as an automobile to provide a safe riding environment for children.

The child safety seat is required to be stably disposed in the vehicle such as an automobile, usually on a seat of the automobile, when the child safety seat is used. Thus, some existing child safety seats include a base and a seat (also called as a basket) detachably engaged on the base, and the base is provided with a top rod and an ISOFIX (standard fixing member) set. However, due to the size difference of various automobiles, there may be a distance between the base and a backrest of a rear seat after ISOFIX is fastened to the rear seat of the automobile, which may cause the base to shake or turn over, resulting in a safety risk.

Some existing child safety seats are required to be fixed by a top tether in addition to an ISOFIX fixing point on the vehicle. For this, the top tether and a top rod structure are generally provided, and the child safety seat is more firmly fixed on the vehicle seat through the cooperation of the top rod and the top tether. However, in some aspects of connecting the top tether to the top rod, when the top tether is used in cooperation with the vehicle seat of some vehicle models, the top tether cannot be straightened after being connected or the top rod cannot lean against a seat back of the vehicle.

FIGS. 12-13B show schematic views of a child safety seat in the prior art. FIG. 13B schematically shows that compared with FIG. 13A, the top rod 2221 may cause the top tether 2130 not being able to be straightened, affecting the safety of the child safety seat 2200. Specifically, in order to cooperate with different vehicle seats, the top rod 2221 will be provided to be adjustable (so that the top rod 2221 leans against the back of the vehicle seat, and the child safety seat 2200 is placed in a direction opposite to a forward direction of the vehicle, that is, the child faces towards the back of the vehicle seat), but the adjustment of the top rod 2221 may cause that the top tether 2130 cannot to be straightened after being connected. The failure to straighten the top tether 2130 may usually cause the original structure of the vehicle to directly limit the child safety seat through the top tether to be changed by the top rod, changing the stress of the top tether. When an accident occurs, the child safety seat 2200 may be turned over (the top rod 2221 of the child safety seat 2200 is pulled upwards by an upward component of the top tether 2130, which is easy to turn the child safety seat 2200 over).

### SUMMARY

An adjustment structure of a child safety seat according to the present disclosure includes: a housing; an abutting member at least partially disposed in the housing and movable between a retracted position in which it extends into the housing and an extended position in which it extends out of the housing with respect to the housing; an adjusting member coupled with the abutting member and operable to move the abutting member to the extended position; and a locking device coupled with the adjusting member and capable of locking the abutting member in the extended position.

In one embodiment, the adjusting member includes an adjusting belt, and the adjusting belt includes an operating end, which extends out of the adjustment structure and is pullable, so that the adjusting belt is movable with respect to the housing; and a connecting end connected to the abutting member, the connecting end driving the abutting member to move to the extended position when the operating end is pulled.

In one embodiment, the abutting member includes: a pivoting end pivotally connected to the housing; a moving end which is opposite to the pivoting end and capable of extending into or out of the housing through pivoting of the abutting member with respect to the housing; an abutting part located at an outer end of the moving end, the abutting part being an outermost part of the abutting part with respect to the housing when the abutting part is in the extended position; and a connecting part located at the moving end and connected with the adjusting belt.

In one embodiment, the abutting member further includes: a limiting part located at the moving end and close to the connecting part, and capable of limiting an extension range of the abutting member by abutting against an inner side of the housing.

In one embodiment, the moving end is formed into an arc surface extending along a moving direction of the abutting member, and the connecting part and the limiting part are located at an inner end of the moving end opposite to the abutting part.

In one embodiment, the locking device includes: an engaging seat disposed in the housing, the adjusting belt extending at least partially along the engaging seat; an engaging member disposed in the housing and on each of both sides of the adjusting belt opposite to the engaging seat, and movable between a locking position and an unlocking position with respect to the housing, when the engaging member is in the locking position, the engaging member prevents the adjusting belt from sliding on the engaging seat, and when the engaging member is in the unlocking position, the engaging member allows the adjusting belt to slide on the engaging seat.

In one embodiment, the engaging seat is provided with a sliding end and a sliding surface extending from the sliding end, and the adjusting belt is disposed on the sliding surface; the connecting end of the adjusting belt is disposed below a back side of the sliding surface, and the adjusting belt sequentially winds around the sliding end from the connecting end, and is in sliding contact with the sliding surface, and then extends out of the adjustment structure, so that a part of the adjusting belt between the operating end and the sliding end forms a corner with respect to a part of the adjusting belt between the sliding end and the connecting end.

In one embodiment, the sliding surface of the engaging seat is provided with first clamping teeth; the engaging member is provided with second engaging teeth at a position facing the adjusting belt, and when the engaging member is in the locking position, the first engaging teeth and the second engaging teeth cooperate with each other to lock the adjusting belt.

In one embodiment, the engaging member is pivotally disposed on the housing via a first pivot, and includes a handle which is capable of being operated outside the housing to pivot the engaging member between the locking position and the unlocking position; the first elastic member is disposed between the engaging member and the housing to bias the engaging member to the locking position.

In one embodiment, when the adjusting belt moves along a retracting direction, the adjusting belt tends to drive the engaging member to pivot towards the locking position; and when the adjusting belt moves along an extending direction, the adjusting belt tends to drive the engaging member to pivot towards the unlocking position.

In one embodiment, the abutting member is pivotally connected to the housing via a second pivot, and the second elastic member is disposed between the abutting member and the housing to bias the abutting member to the retracted position.

A base structure of a child safety seat according to the present disclosure includes: a base; the adjustment structure according to the present disclosure. The adjustment structure is disposed at a front end of the base, and an abutting member of the adjustment structure is capable of extending longitudinally with respect to the base; and a top rod extending vertically upwards along an upper surface of the housing of the adjustment structure.

The present disclosure provides a top rod structure disposed on a base of a child safety seat. The top rod structure includes: a top rod including an upper top rod and a lower top rod which are pivoted with each other, the upper top rod being pivotable with respect to the lower top rod, and the lower top rod being configured to lean against one side of a vehicle seat back.

In one embodiment, the top rod is in a substantially inverted U-shape, and two upper top rods meet at a top of the inverted U-shape to form a leaning part.

In one embodiment, the top rod structure includes a connecting part adjacent to the leaning part, and a penetration is formed between the leaning part and the connecting part for the top tether to pass through.

In one embodiment, one end of the upper top rod towards the lower top rod is provided with an upper top rod rotating seat, one end of the lower top rod towards the upper top rod is provided with a lower top rod rotating seat, and the upper top rod rotating seat is installed in cooperation with the lower top rod rotating seat to realize a mutual pivoting of the upper top rod and the lower top rod.

In one embodiment, one of the upper top rod rotating seat and the lower top rod rotating seat is provided with a limiting protrusion, and the other of the upper top rod rotating seat and the lower top rod rotating seat is provided with a limiting groove, and the limiting protrusion cooperates with the limiting groove to limit a rotation angle of the upper top rod with respect to the lower top rod.

In one embodiment, the top rod structure includes: a connecting shaft, wherein the upper top rod rotating seat and the lower top rod rotating seat are pivoted through the connecting shaft.

In one embodiment, the top rod structure includes: a third torsion spring disposed between the upper top rod rotating seat and the lower top rod rotating seat, the third torsion spring constantly biasing the upper top rod in a direction along the same straight line as the lower top rod.

The present disclosure provides a child safety seat including a body and a base, wherein the base is provided with the top rod structure according to the present disclosure.

In one embodiment, the lower top rod is pivotally installed to the base to be away from or close to the base.

In one embodiment, the child safety seat includes: an adjusting belt and a locking member disposed on the base, wherein a lower end of the lower top rod is controlled to pivot with respect to the base through the adjusting belt and the locking member.

A child safety seat according to the present disclosure comprises a body and the base structure according to the present disclosure or the top rod structure according to the present disclosure.

In one embodiment, the lower top rod is pivotally installed to the base to be away from or close to the base.

In one embodiment, the top rod structure includes a pivoting shaft, the lower top rod is pivotally installed on a connecting bracket through the pivoting shaft, and the connecting bracket is connected to a base bracket longitudinal part of the base.

In one embodiment, the child safety seat includes: a fixing member passing through the penetration at one end of the pivoting shaft to limit the lower top rod to the pivot shaft.

In one embodiment, the child safety seat includes: a first torsion spring disposed between the pivoting shaft and the connecting bracket, wherein the first torsion spring constantly biases the lower top rod in a direction close to the base.

In one embodiment, one end of the adjusting belt is connected with the lower top rod, and the other end of the adjusting belt winds around a winding part disposed on the base downwards and then extends upwards, passing through the locking member and extending out of the base to form an operating end, and a position of the top rod with respect to the base is adjustable by operating the operating end.

In one embodiment, the base includes a track, and the track is disposed at a pivotal installation position of the lower top rod and the base, and the lower top rod is movable downwards or upwards in the track of the base and pivots in a direction away from or close to the base.

In one embodiment, the adjusting belt is a Y-shaped belt with three ends, two ends of the adjusting belt are connected with the two lower top rods, and the remaining end of the adjusting belt winds around the winding part disposed on the base downwards and then extends upwards, passing through the locking member and extending out of the base to form an operating end, and the top rods is capable of being adjusted with respect to the base by operating the operating end.

In one embodiment, a transverse rod is connected to the lower top rod, one end of the adjusting belt is connected to the transverse rod, and the winding part is a bracket connected to a base bracket transverse part of the base.

In one embodiment, the locking member includes a first locking part, a second locking part, and a second torsion spring that applies a torsion between the first locking part and the second locking part, the adjusting belt passes between the first locking part and the second locking part, and the second torsion spring constantly presses the first locking part against the second locking part to lock the adjusting belt between the first locking part and the second locking part.

In one embodiment, the locking member further includes an operating part, and the locking member is unlocked through the operating part, wherein a force applied to the operating part when unlocking is greater than a torsion applied by the second torsion spring.

In one embodiment, the locking member is a tooth engagement mechanism, the first locking part is a toothed wheel and the second locking part is a rack.

In one embodiment, the track is an elongated slot in the base for the lower top rod to move upwards and downwards in the elongated slot.

### BRIEF DESCRIPTION OF THE DRAWINGS

FIG. 1 is a perspective view of a child safety seat according to a first embodiment of the present disclosure, in which an adjustment structure is in a retracted state.

FIG. 2 is a perspective view of the child safety seat according to the present disclosure, in which the adjustment structure is in an extended state.

FIG. 3 is another perspective view of the child safety seat according to the present disclosure, in which a part of the seat is omitted to clearly show the adjustment structure and the base, and the adjustment structure is in the retracted state.

FIG. 4 is another perspective view of the child safety seat according to the present disclosure, in which a part of the seat is omitted to clearly show the adjustment structure and the base, and in which the adjustment structure is in the extended state.

FIG. 5 is a side sectional view of the adjustment structure according to the present disclosure, in which the adjustment structure is in the retracted state.

FIG. 6 is a side sectional view of the adjustment structure according to the present disclosure, in which the adjustment structure is in the extended state.

FIG. 7 is a perspective view of the adjustment structure according to the present disclosure, in which the adjustment structure is in the retracted state.

FIG. 8 is a perspective view of the adjustment structure according to the present disclosure, in which the adjustment structure is in the extended state.

FIG. 9 is a perspective view of the adjustment structure according to the present disclosure, in which a part of the housing is removed to show other components of the adjustment structure.

FIG. 10 is a perspective view of the adjustment structure according to the present disclosure, in which a part of the housing and an engaging member are removed to show other parts of the adjustment structure.

FIG. 11 is a perspective view of an adjusting belt, an engaging seat and an abutting member of the adjustment structure according to the present disclosure.

FIG. 12 is a perspective view of a child safety seat in the prior art.

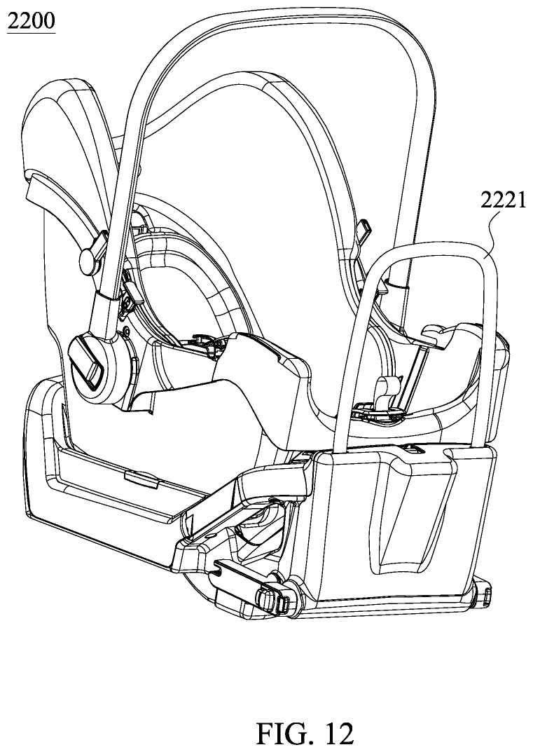

FIGS. 13A and 13B are schematic side views of the child safety seat in the prior art, wherein FIG. 13B schematically shows that compared with FIG. 13A, the top tether may not be straightened after the top rod is adjusted, which affects the safety of the child safety seat.

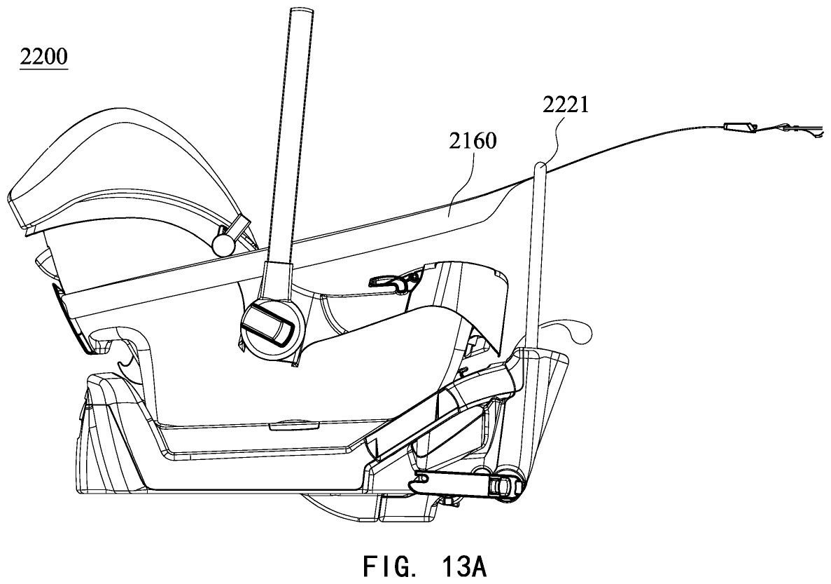

FIG. 14 is a schematic perspective view of the child safety seat according to a second embodiment of the present disclosure, in which the top rod is away from the base.

FIG. 15 is a schematic perspective view of the child safety seat according to the present disclosure, in which the top rod is close to the base.

FIG. 16 is a perspective view of the base of the child safety seat according to the present disclosure.

FIG. 17 is a schematic side view of the base of the child safety seat according to the present disclosure, in which an upper top rod is pivoted with respect to a lower top rod to form a straight line.

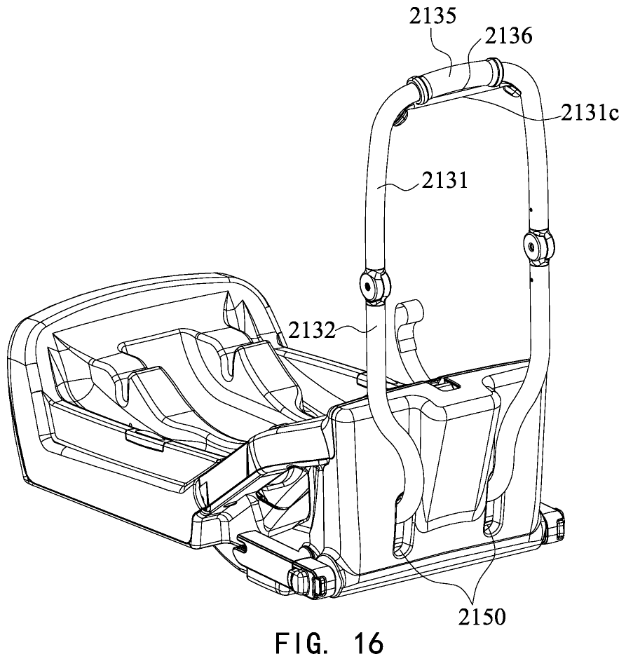

FIG. 18 is a schematic side view of the base of the child safety seat according to the present disclosure, in which the upper top rod is pivoted with respect to the lower top rod to form an included angle.

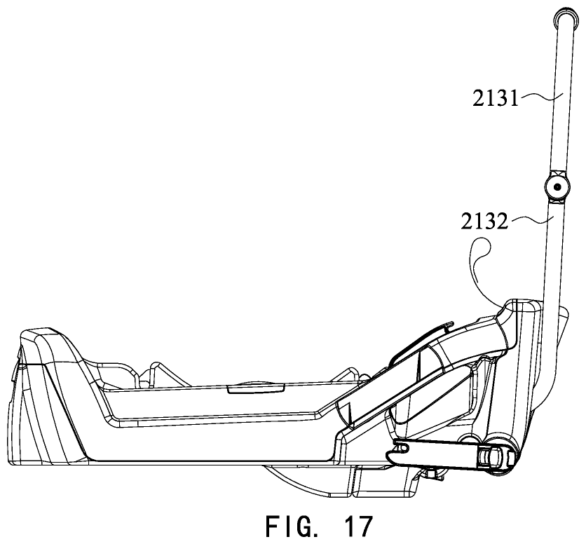

FIG. 19 is a schematic side view of the child safety seat according to the present disclosure, in which the top rod is away from the base and the upper top rod is pivoted with respect to the lower top rod to form an included angle.

FIG. 20 is a schematic side view of the child safety seat according to the present disclosure, in which the top rod is close to the base and the upper top rod is pivoted with respect to the lower top rod to form an included angle.

FIG. 21 is a perspective view of the interior of the base of the child safety seat according to the present disclosure.

FIG. 22 is an enlarged schematic view of a framed area A in FIG. 21, specifically showing a schematic view of the lower top rod of the child safety seat pivoting with the base according to the present disclosure.

FIG. 23 is a schematic side view of the base of the child safety seat according to the present disclosure, and shows a partial sectional view of the top rod structure.

FIG. 24 is an enlarged schematic view of a framed area B in FIG. 23, and specifically shows a schematic view of connection of an adjusting belt with the base and the lower top rod of the child safety seat according to the present disclosure.

FIG. 25A is an enlarged schematic view of a framed area C in FIG. 24, specifically showing a locking member of the child safety seat according to the present disclosure.

FIG. 25B is a schematic view according to FIG. 25A after the adjusting belt is omitted, and specifically shows a second locking part of the locking member of the child safety seat according to the present disclosure.

FIG. 26 is a perspective view of an upper top rod rotating seat of the child safety seat according to the present disclosure.

FIG. 27 is a perspective view of a lower top rod rotating seat of the child safety seat according to the present disclosure.

FIG. 28 is an exploded schematic view of the top rod of the child safety seat according to the present disclosure.

FIG. 29 is a schematic side view of the base of the child safety seat according to the present disclosure, and shows a partial sectional view of the top rod.

FIG. 30 is an enlarged schematic view of a framed area D in FIG. 29, specifically showing the assembly relationship between the upper top rod rotating seat and the lower top rod rotating seat of the child safety seat according to the present disclosure.

### LIST OF REFERENCE NUMBERS

1001 Child Safety Seat
1100 Adjustment Structure
   1110 Housing
      1111 First Inner Wall
      1112 Second Inner Wall
   1120 Adjusting Belt (Adjusting Member)
      1121 Operating End
      1122 Connecting End
   1130 Abutting Member
      1131 Abutting Part
      1132 Pivoting End
      1133 Connecting Part
      1134 Limiting Part
      1139 Moving End
   1140 Engaging Seat
      1141 Sliding Surface
      1142 Sliding End
      1143 First Engaging Tooth/Teeth
   1150 Engaging Member
      1151 Handle
      1152 Second Engaging Tooth/Teeth
   1160 First Pivot
   1170 Second Pivot
   1180 First Elastic Member
   1190 Second Elastic Member
1200 Top Rod
1300 Connecting Part
1400 Seat (Sleeping Basket)
1500 Base
2200 Safety Seat
   2221 Top Rod
2100 Child Safety Seat
   2110 Seat Body
      2120 Base
      2130 Top Rod
         2131 Upper Top Rod
         2131c Connecting Part
         2131t Upper Top Rod Rotating Seat
         2131tp Limit Protrusion
         2132 Lower Top Rod
         2132b Lower Top Rod Rotating Seat
         2132bg Limit Groove
         2133 Connecting Shaft
         2134 Third Torsion Spring
         2135 Leaning Part
         2136 Penetration
      2122 Pivoting Shaft
      2123 Connecting Bracket
      2124 Base Bracket Longitudinal Part
      2125 Fixing Member
      2126 First Torsion Spring
      2127 Adjusting Belt
         2127a Operating End
      2128 Transverse Rod
      2129 Winding Part
      2170 Base Bracket Transverse Part
      2140 Locking Member
         2141 First Locking Part
         2142 Second Torsion Spring
         2143 Operating Part
         2144 Second Locking Part
      2150 Track
   2160 Top Tether

### DETAILED DESCRIPTION

Although the present disclosure is illustrated and described herein with reference to specific embodiment, the present disclosure should not be limited to the details shown. Rather, various modifications may be made to these details within the scope of equivalents of the claims without departing from the present disclosure.

The descriptions of directions such as “front”, “rear”, “upper” and “lower” in this text are only for convenience of understanding, and the present disclosure is not limited to these directions, but can be adjusted according to the actual situation. Although the present disclosure has been described with reference to typical embodiments, the terminology used is illustrative and exemplary, not restrictive.

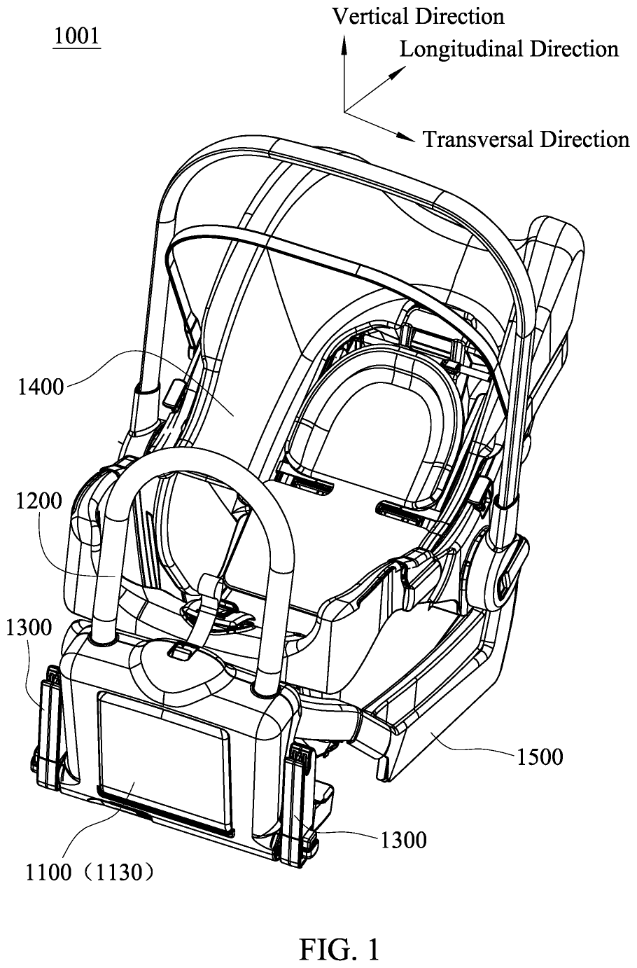

Referring to FIGS. 1-4, a child safety seat 1001 according to the present disclosure is described. The child safety seat 1 includes a seat 1400 and a base structure. In the present disclosure, the “base structure” includes a base 1500, an adjustment structure 1100, a top rod 1200, and a connecting part 1300. The seat 1400 is installed on the base 1500 of the base structure, and may be replaced by a sleeping basket.

More specifically, the seat 1400 is installed vertically above the base 1500. The adjustment structure 1100 is disposed inside the base 1500 and may extend rearwards from the base 1500 in a longitudinal direction (more specifically, the abutting member 1130 extends rearwards from the base 1500) so as to abut against, for example, a backrest of a rear seat to install the child safety seat 1001. The top rod 1200 extends vertically upwards from the base 1500. The connecting part 1300 is disposed at both sides of the base 1500. In this embodiment, the connecting part 1300 may be an ISOFIX (standard fixing member) for connecting with the corresponding anchor between a backrest and a cushion of the vehicle seat. It should be understood that positions and directions of the seat 1400, the adjustment structure 1100, the top rod 1200 and the connecting part 1300 with respect to the base 1500 are only illustrative and can be changed according to the actual situation. It should also be understood that the adjustment structure 1100 according to the present disclosure may be applied to other environments and is not limited to the child safety seat 1001.

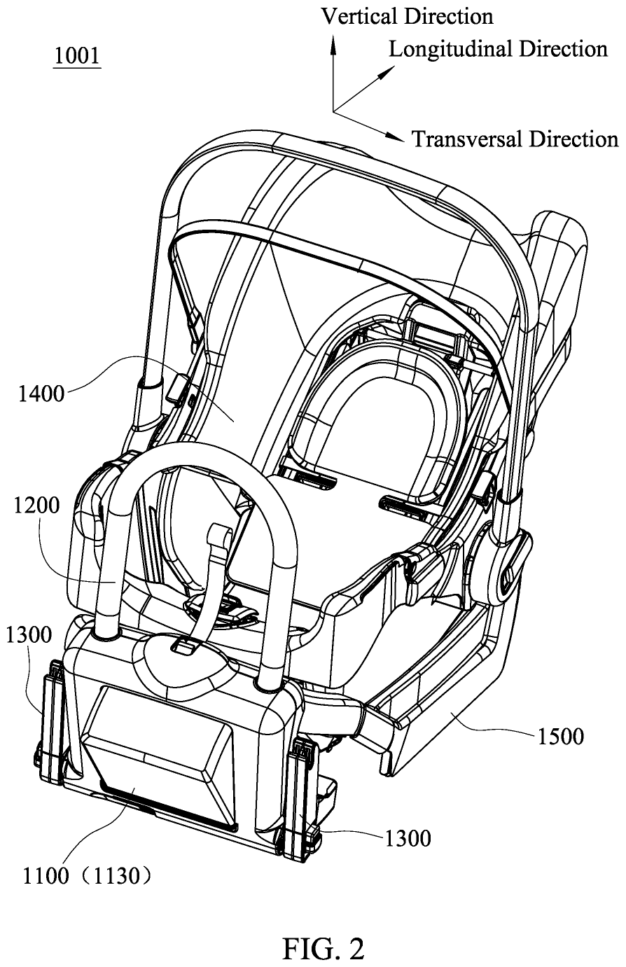

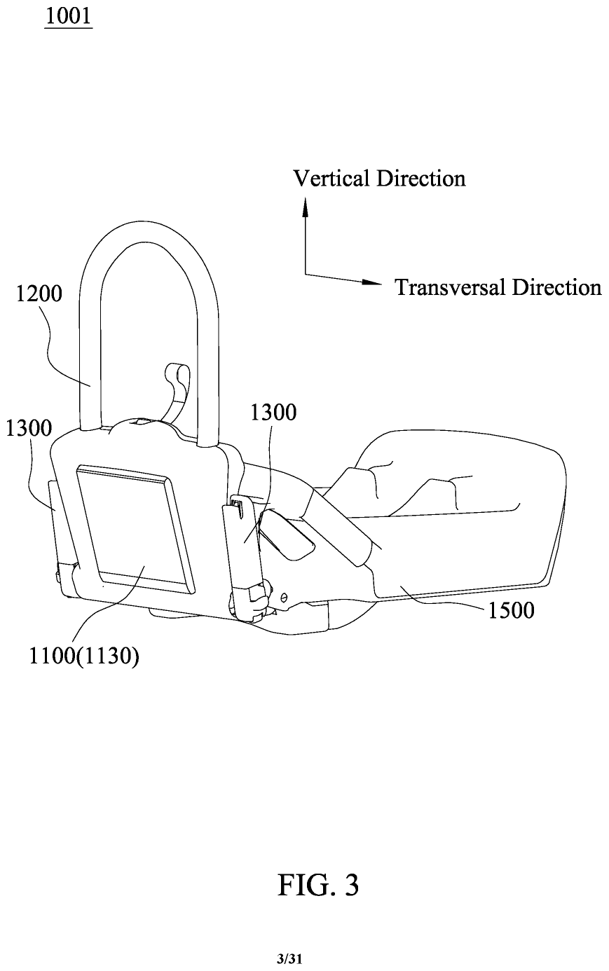

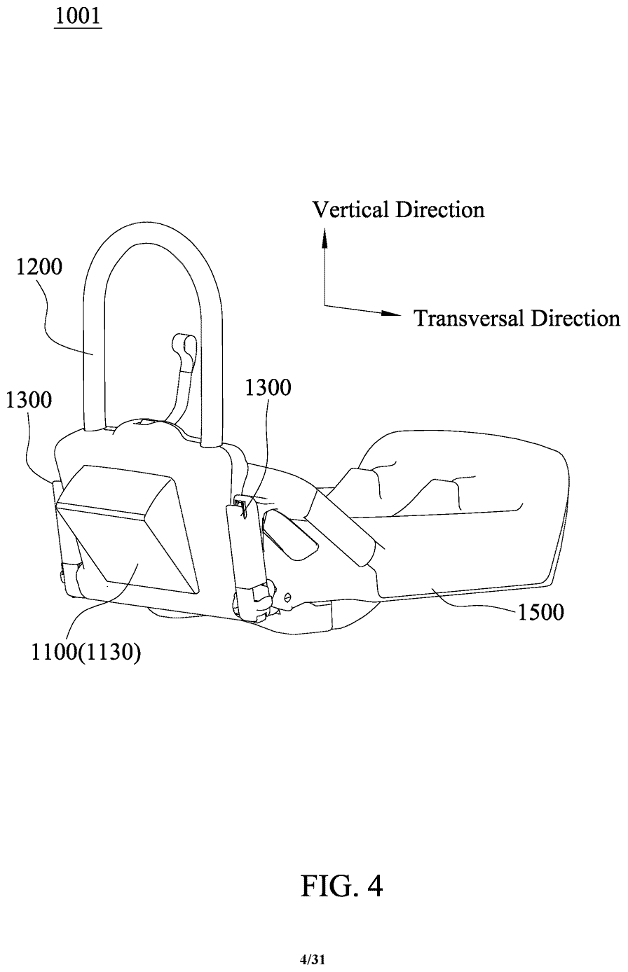

FIGS. 1 and 3 show the adjustment structure 1100 in a retracted position. FIGS. 2 and 4 show the adjustment mechanism in an extended position. However, it should be understood that the position shown in any of FIGS. 2 and 4 is only one of the extended positions, and any of positions between the positions shown in FIGS. 1 and 3 and those shown in FIGS. 2 and 4 can be called as “extended position”. Due to different sizes of automobiles, there may be a gap between the base 1500 of the child safety seat 1001 and the backrest of the rear seat in some automobiles after the child safety seat is engaged with ISOFIX, and the adjustment structure 1100 may be in any appropriate extended position (that is, a push block may extend backwards by any appropriate distance). At this time, this gap may be compensated to adapt to various models of automobiles, and it can be ensured that the base 1500 abuts against the backrest of the rear seat, thus preventing the base from shaking or turning over.

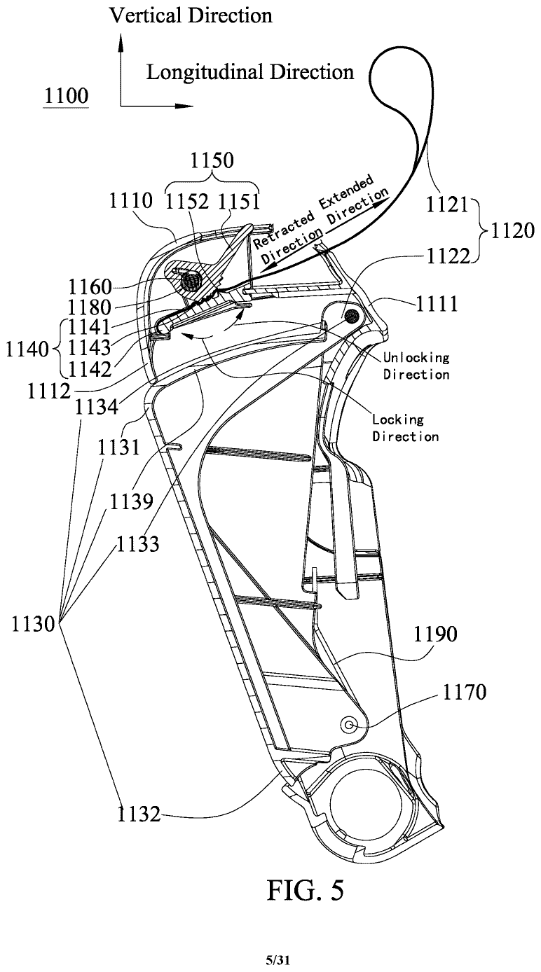

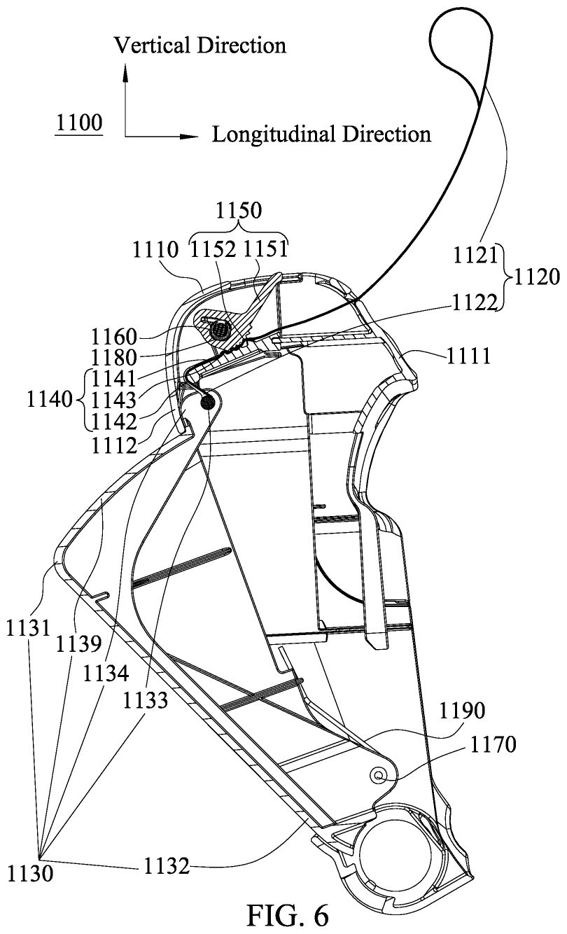

A specific structure of an adjustment structure 1100 according to an embodiment of the present disclosure is described with reference to FIGS. 5 to 11. As shown in FIGS. 5 and 6, the adjustment structure 1100 includes a housing 1110, an adjusting belt 1120, an abutting member 1130, an engaging seat 1140, an engaging member 1150, a first pivot 1160, a second pivot 1170, a first elastic member 1180 and a second elastic member 1190.

The housing 1110 is connected to the base 1500, for example, at the rear of the base 1500 in a longitudinal direction. The housing 1110 has a hollow structure and at least partially houses other components of the adjustment structure 1100.

The abutting member 1130 is at least partially disposed in the housing 1110 and movable with respect to the housing 1110 between a retracted position (FIG. 5) in which it extends into the housing 1110 and an extended position (FIG. 6) in which it extends out of the housing 1110.

More specifically, the abutting member 1130 includes a pivoting end 1132, a moving end 1139, an abutting part 1131, a connecting part 1133 and a limiting part 1134. The pivoting end 1132 is pivotally connected to the housing 1110. The moving end 1139 is opposite to the pivoting end 1132, and may extend into or out of the housing 1110 by pivoting the abutting member 1130 with respect to the housing 1110.

In this embodiment, the pivoting end 1132 is connected to a vertical lower end of the housing 1110, the moving end 1139 is close to a vertical upper end of the housing 1110, a lower end of the abutting member 1130 is constantly connected to the housing 1110 while an upper end of the abutting member 1130 may protrude with respect to the housing 1110, which is beneficial to the stable installation of the child safety seat 1001 and facilitates the user to observe a state of the abutting member 1130. However, it should be understood that in other embodiments, the pivoting end 1132 may be connected to other positions of the housing 1110, such as the vertical upper end of the housing 1110, or a horizontal left or right end, and the position of the moving end 1139 will change accordingly.

The abutting part 1131 is located at an outer end of the moving end 1139. When the abutting member 1130 is in the extended position, the abutting part 1131 is an outermost part of the abutting member 1130 with respect to the housing 1110. The connecting part 1133 is located at the moving end 1139 and connected with the connecting end 1122 of the adjusting belt 1120.

Since the abutting part 1131 and the connecting part 1133 are away from the pivoting end 1132, according to the lever principle, when the abutting member 1130 is impacted by an external force, the abutting part 1131 and the connecting part 1133 receive the minimum impact force, thus avoiding the accidental disengagement of the abutting member 1130 from the extended position as much as possible.

The limiting part 1134 is located at the moving end 1139 and close to the connecting part 1133, and may limit an extension range of the abutting part 1130 by abutting against an inner side of the housing 1110. More specifically, the limiting part 1134 extends from the moving end 1139 towards the inside of the housing 1110 in a substantially vertical direction. In this way, when the abutting member 1130 moves to a retracted position (FIG. 5) or the maximum extended position (FIG. 6), the limiting part 1134 abuts against an inner side of a first inner wall 1111 and an inner side of a second inner wall 1112 of the housing 1110, respectively, to prevent the abutting member 1130 from moving excessively. The first inner wall 1111 is formed at a relatively inner part of the housing 1110 in a longitudinal direction (i.e., the longitudinal front of the housing), and the second inner wall 1112 is formed at a relatively outer part of the housing 1110 (i.e., the longitudinal rear of the housing). The first inner wall 1111 and the second inner wall 1112 are opposite to each other. A distance between the first inner wall 1111 and the second inner wall 1112 is approximately equal to a stroke of the moving end 1139 with respect to the housing 1110.

In this embodiment, the moving end 1139 is formed as an arc surface extending along a moving direction (i.e., the longitudinal direction in this embodiment) of the abutting member 1130, and the connecting part 1133 and the limiting part 1134 are located at an inner end of the moving end 1139 opposite to the abutting part 1131. In this way, when the adjustment structure 1100 moves between the retracted position and the extended position, the connecting part 1133 and the limiting part 1134 are constantly located inside the housing 1110, which is beneficial to the neat appearance of the adjustment structure 1100.

In this embodiment, the abutting member 1130 is pivotally connected to the housing 1110 at the pivoting end 1132 through the second pivot 1170, so as to rotate with respect to the housing 1110. However, in other embodiments, the abutting member 1130 may also be disposed to move linearly or curvedly with respect to the housing 1110, such as sliding along a linear or curved track.

The adjusting belt 1120 is described with continued reference to FIGS. 5 and 6. The adjusting belt 1120 is coupled with the abutting member 1130 and may be operated to move the abutting member 1130 to the extended position. In this embodiment, the adjusting belt 1120 is a belt such as a fabric. In other embodiments, the adjusting belt 1120 may be an adjusting member in other forms such as an adjusting rod and an adjusting bolt.

More specifically, the adjusting belt 1120 includes an operating end 1121 that extends out of the adjustment structure 1100 and is pullable so that the adjusting belt 1120 may move with respect to the housing 1110; and a connecting end 1122 connected to the abutting member 1130. When the operating end 1121 is pulled, the connecting end 1122 drives the abutting member 1130 to move to the extended position. The user pulls the abutting member 1130 through the adjusting belt 1120 to move the abutting member 1130 with respect to the housing 1110.

In this embodiment, the adjusting belt 1120 winds around the engaging seat 1140, that is, the operating end 1121 and the connecting end 1122 of the adjusting belt 1120 are at one side of the engaging seat 1140, such as a longitudinal front side, and a middle portion of the adjusting belt 1120 is wound around the other side of the engaging seat 1140, such as a longitudinal rear side. In this way, it is beneficial to increase the friction between the adjusting belt 1120 and the engaging seat 1140, thus preventing the abutting member 1130 from accidentally disengaging from the extended position. In other embodiments, the adjusting belt 1120 may simply extend along the engaging seat 1140, that is, from one side of the engaging seat 1140 to the other side.

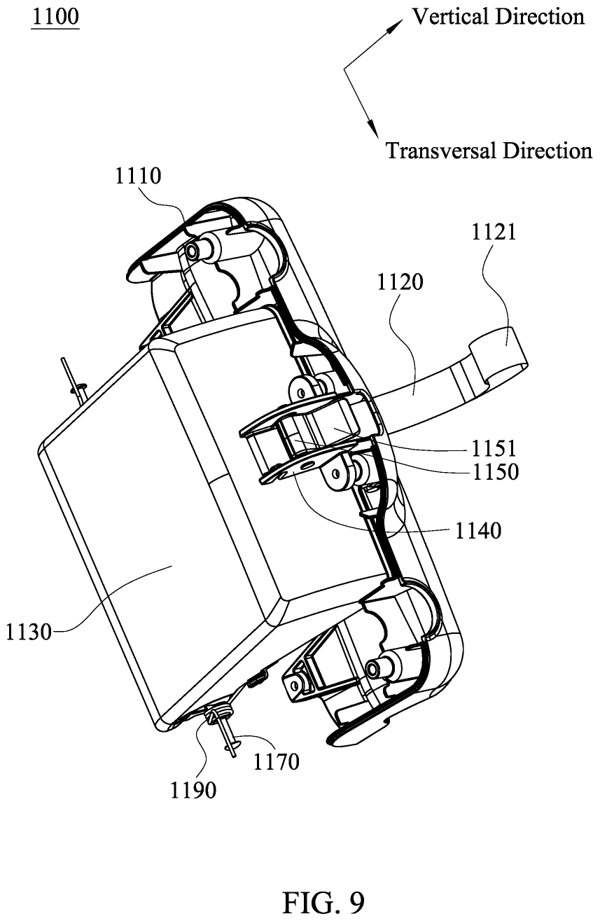

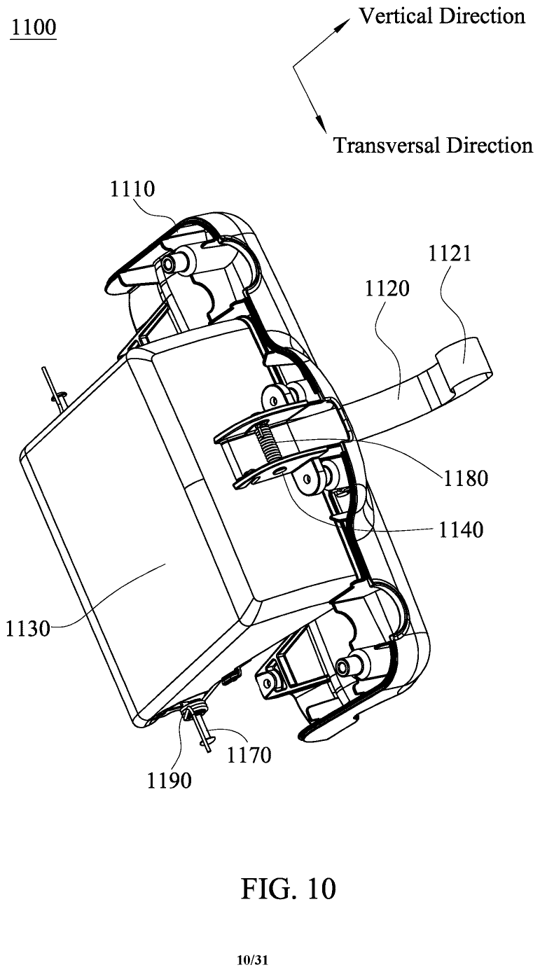

As the adjusting belt 1120 is a flexible fabric and thus cannot be used to push the abutting member 1130 back to the retracted position. A return spring, that is, a second elastic member 1190 (FIGS. 9 and 10) is provided, so that the abutting member 1130 automatically rebounds from the extended position to the retracted position. The second elastic member 1190 is, for example, a coil spring wound on the second pivot 1170. In this way, as long as the user releases the adjusting belt 1120 through the locking device (i.e., the engaging member 1150 and the engaging seat 1140), the abutting member 1130 will automatically return to the retracted position.

The engaging seat 1140 and the engaging member 1150 are described with reference to FIGS. 5 to 10. The engaging seat 1140 and the engaging member 1150 are coupled with the adjusting belt 1120 and may lock the abutting member 1130 in the extended position. More specifically, the engaging seat 1140 and the engaging member 1150 cooperate with each other to prevent the adjusting belt 1120 from moving, and thus the abutting member 1130 is locked in the extended position. In this embodiment, the engaging seat 1140 and the engaging member 1150 are collectively referred to as the locking device. In other embodiments, the locking device may be in an appropriate form, such as a buckle, a fixing screw, and the like.

More specifically, the engaging seat 1140 is disposed (for example, fixedly disposed) inside the housing 1110, and the adjusting belt 1120 extends at least partially along the engaging seat 1140.

The engaging seat 1140 has a sliding end 1142 and a sliding surface 1141 extending from the sliding end 1142, and the adjusting belt 1120 is disposed on the sliding surface 1141. The connecting end 1122 of the adjusting belt 1120 is disposed below a back side of the sliding surface 1141, and the adjusting belt 1120 sequentially winds around the sliding end 1142 from the connecting end 1122, and is in sliding contact with the sliding surface 1141, and then extends out of the adjustment structure 1100, so that a part of the adjusting belt 1120 between the operating end 1121 and the sliding end 1142 forms a corner with respect to a part of the adjusting belt 1120 between the sliding end 1142 and the connecting end 1122.

As mentioned above, the adjusting belt 1120 winds around the engaging seat 1140, which is beneficial to increase the friction between the adjusting belt 1120 and the engaging seat 1140.

The engaging member 1150 is disposed inside the housing 1110, on each of both sides of the adjusting belt 1120 opposite to the engaging seat 1140, and may move between a locking position and an unlocking position with respect to the housing 1110 or the engaging seat 1140. When the engaging member 1150 is in the locking position, the engaging member 1150 prevents the adjusting belt 1120 from sliding on the engaging seat 1140, and when the engaging member 1150 is in the unlocking position, the engaging member 1150 allows the adjusting belt 1120 to slide on the engaging seat 1140.

More specifically, the engaging member 1150 is pivotably disposed on the housing 1110 via the first pivot 1160, and includes a handle 1151 that may be operated outside the housing 1110 to pivot the engaging member 1150 between the locking position and the unlocking position. The first elastic member 1180 is disposed between the engaging member 1150 and the housing 1110 to bias the engaging member 1150 towards the locking position.

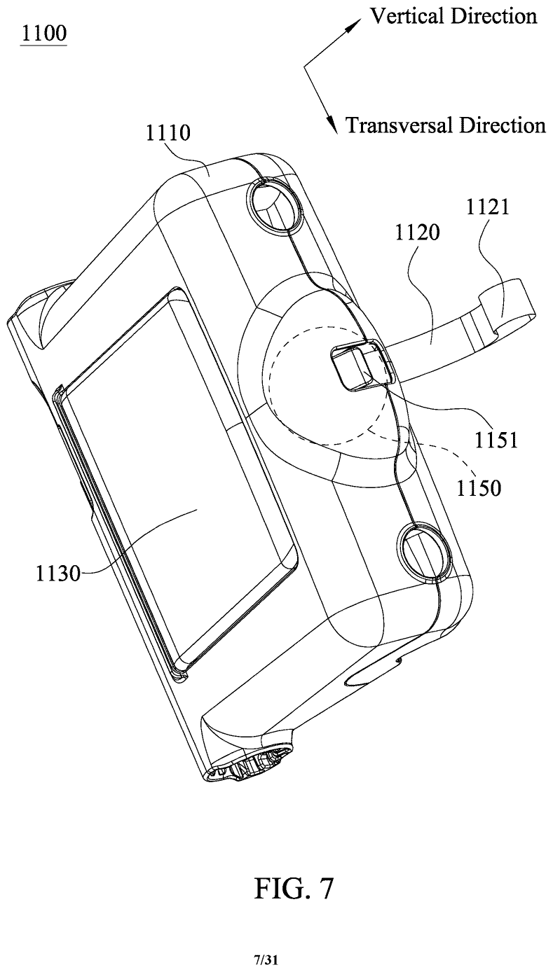

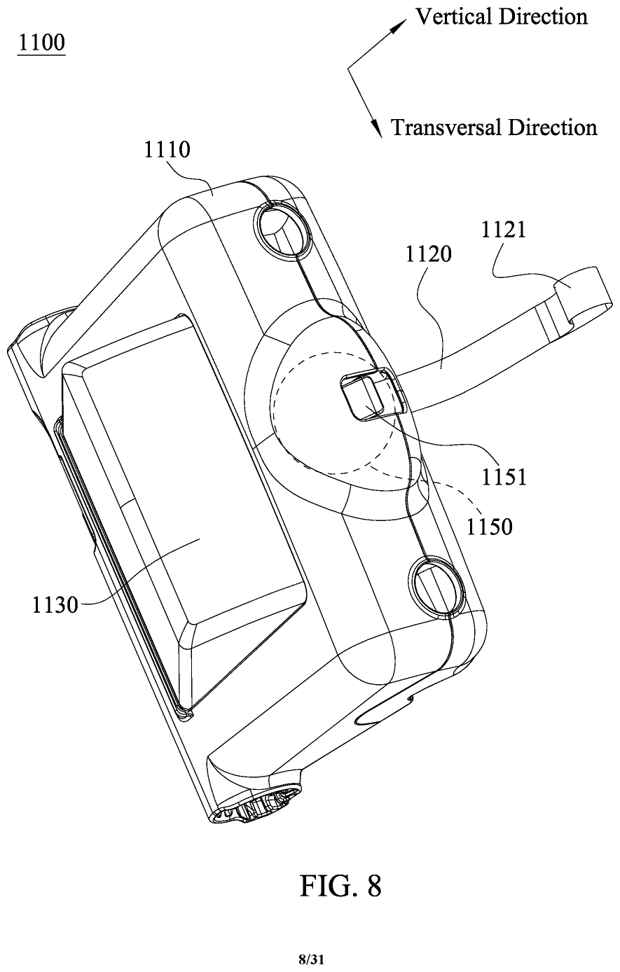

In this embodiment, the engaging member 1150 is located vertically above the engaging seat 1140. As shown in FIGS. 7 to 8, both the handle 1151 and the operating end 1121 are located at the vertical upper end of the housing 1110. As the adjustment structure 1100 is located at the lower end of the child safety seat 1001, the positions of the handle 1151 and the operating end 1121 as mentioned above are beneficial for the user to operate the adjustment structure 1100. However, in other embodiments, the engaging member 1150 may also be disposed in other directions of the engaging seat 1140, such as the longitudinal front or the transverse left or right side.

In this embodiment, the sliding surface 1141 of the engaging seat 1140 is provided with first engaging teeth 1143. The engaging member 1150 is provided with second engaging teeth 1152 at a position facing towards the adjusting belt 1120. When the engaging member 1150 is in the locking position, the first engaging tooth 1143 and the second engaging tooth 1152 cooperate with each other to clamp a part of the adjusting belt 1120 on the sliding surface 1141 between the first engaging teeth 1143 and the second engaging teeth 1152 to lock the adjusting belt 1120, so that the adjusting belt will no longer slide. When the engaging member 1150 is in the unlocking position, the first engaging teeth 1143 is no longer engaged with the second engaging teeth 1152 along with the rotation of the engaging member 1150, forming an avoiding space therebetween and thereby allowing the adjusting belt 1120 to move. In other embodiments, there may be other appropriate locking structure(s) between the engaging member 1150 and the engaging seat 1140, such as a cam locking structure or a caliper locking structure.

In addition, as shown in FIG. 5, when the adjusting belt 1120 moves along a retracting direction, the adjusting belt 1120 tends to drive the engaging member 1150 to rotate in a locking direction (i.e., in a clockwise direction in FIG. 5). In this way, unless the user pulls the engaging member 1150 in an unlocking direction (i.e., in a counterclockwise direction in FIG. 5), the engaging member 1150 will firmly clamp the adjusting belt 1120 on the engaging seat 1140. That is, the locking device composed of the engaging seat 1140 and the engaging member 1150 has an automatic locking function. On the contrary, when the adjusting belt 1120 moves in the extending direction, the adjusting belt 1120 tends to drive the engaging member 1150 to rotate in the unlocking direction. In this way, even if the user does not pull the engaging member 1150, the engaging member 1150 may automatically rotate to the unlocking position. That is, the locking device composed of the engaging seat 1140 and the engaging member 1150 has an automatic unlocking function. In addition, the foot/feet of a child may unintentionally press down on the engaging member 1150, especially on the handle 1151, and the unlocking direction is a direction in which the handle 1151 tends to move upwards, so that even if the engaging member 1150 is unintentionally pressed, the engaging member 1150, the adjusting belt 1120 will not be unlocked to cause the abutting member 1130 to be retracted, so as to constantly ensure an abutting state.

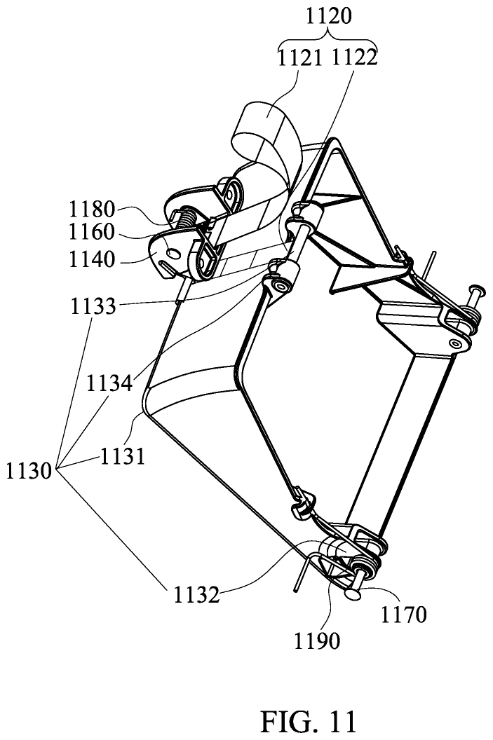

FIG. 11 shows the connection relationship between the abutting member 1130, the engaging seat 1140 and the adjusting belt 1120. It can be seen from FIG. 11 that the connecting end 1122 of the adjusting belt 1120 winds around the engaging seat 1140 and is connected to the connecting part 1133 of the abutting member 1130.

In summary, the present disclosure provides an adjustment structure for a child safety seat, which may abut against a seat of an automobile. Considering the size difference of various automobiles, the adjustment mechanism should be in a form of stepless adjustment. Moreover, it is necessary for the adjustment structure to be as simple as possible, and also has functions of automatic locking and automatic unlocking.

When the top tether of the child safety seat of a second embodiment of the present disclosure is connected with the top rod, properly adjusting the top rod structure may avoid the top tether from being obviously bent. No matter what position the top rod is adjusted to, the top rod can not only reliably lean against the seat back of the vehicle, but also the top tether can be substantially straightened after being connected, so that the child safety seat can be connected to the vehicle seat more safely and the possibility of overturning the child safety seat in an accident event can be avoided.

The top rod structure of the present disclosure can not only pivot with respect to the base of the child safety seat to adapt to different seat backs of vehicles so that the top rod can firmly lean against the seat back of the vehicle, but also an upper top rod and a lower top rod of the top rod structure can pivot with each other, thereby preventing the top tether from being excessively bent when the top tether is installed on the seat back of the vehicle through the top rod structure due to the obstruction of the top rod structure.

The present disclosure provides a child safety seat. When the top tether is connected with the top rod, the top rod can not only reliably lean against the seat back of the vehicle, but also will not affect the straightening of the top tether.

The present disclosure avoids that the top tether 130 cannot be straightened when the top tether 130 is connected with the top rod 221.

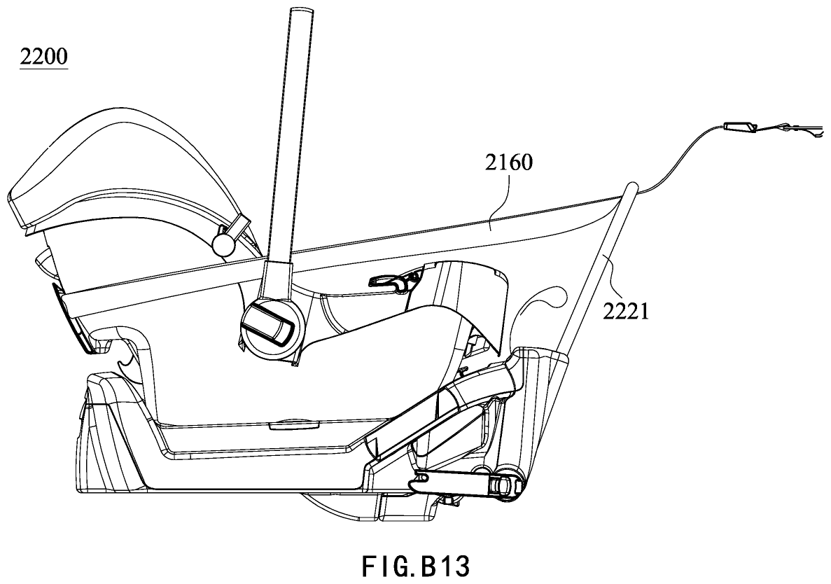

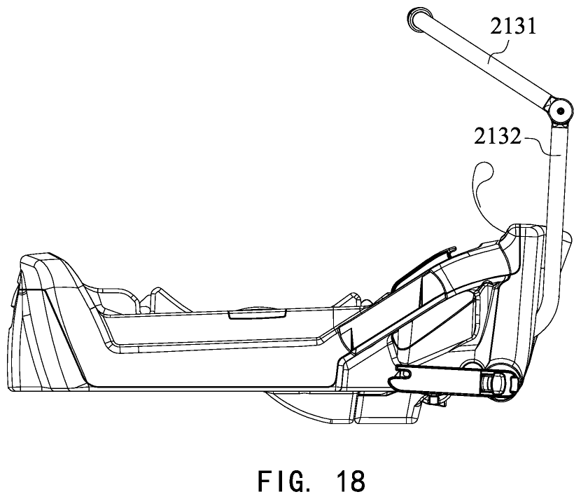

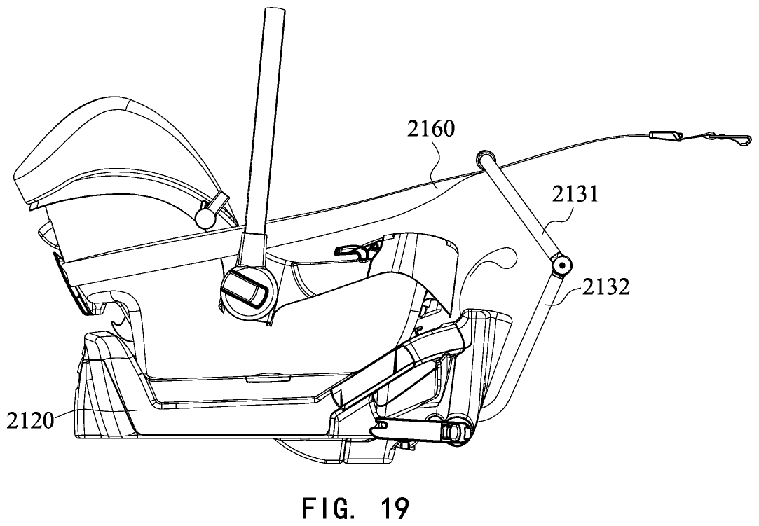

FIG. 14 shows the top rod structure of the present disclosure, which is disposed on the base 2120 of the child safety seat 2100 for placing the seat body 2110. The top rod structure includes a top rod 2130. The top rod 2130 includes an upper top rod 2131 and a lower top rod 2132 which are pivoted with each other. The lower top rod 2132 is configured to lean against one side of the seat back of the vehicle. The upper top rod 1211 is configured for the top tether 2160 to pass through to connect the top tether 2160 with the top rod 2130. At the same time, one end of the top tether 2160 is connected with the seat body 2110, and the other end thereof is connected with the vehicle (as shown in FIGS. 19 and 20, which will be further described below).

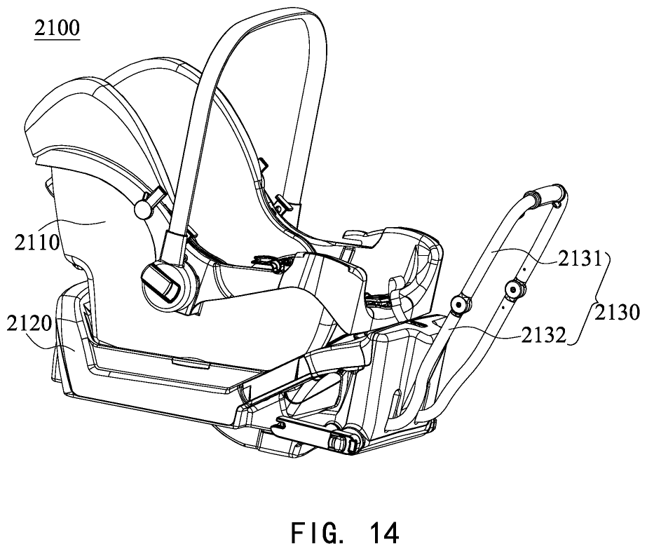

FIG. 14 shows a state that the top rod 2130 of the child safety seat 2100 is away from the base 2120 according to the present disclosure. FIG. 15 shows a state that the top rod 2130 of the child safety seat 2100 is close to the base 2120 according to the present disclosure. As shown in FIGS. 14-15, a lower end of the lower top rod 2132 may be pivotally installed on the base 2120 to be away from or close to the base 2120. The upper top rod 2131 may pivot about the lower top rod 2132 in a direction close to the lower top rod 2132, so that the top rod 2130 will not affect the straightening of the top tether 2160. Specifically, a force may be applied to the upper top rod 2131 to rotate the upper top rod 2131 towards the lower top rod 2132 in the counterclockwise direction shown in FIG. 15, and be close to the lower top rod 2132, so as to ensure that the top rod 2130 will not affect the straightening of the top tether 2160. In other words, the upper top rod 2131 may pivot about the lower top rod 2132 in a direction close to the base 2120 (i.e., the upper top rod 2131 may pivot about the lower top rod 2132 in a first direction, and the first direction is the counterclockwise direction shown in FIG. 15), so that the top rod 2130 will not affect the straightening of the top tether 2160.

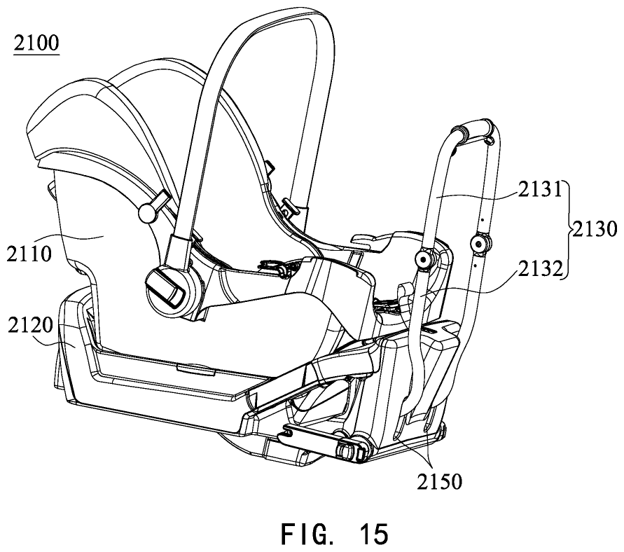

FIG. 16 is a perspective view of the base of the child safety seat according to the present disclosure. As shown in FIGS. 15 and 16, the top rod 2130 is in a substantially inverted U-shape, and each of legs of the inverted U-shape includes the upper top rod 2131 and the lower top rod 2132, and two upper top rods 2131 meet at the top of the inverted U-shape to form a leaning part 2135. The top rod structure includes a connecting part 2131c, which is adjacent to the leaning part 2135. Further, a connecting part 2131c is disposed at an inner side of the leaning part 2135, and both ends of the connecting part 2131c are connected to two opposite sides of the leaning part 2135 (specifically, two bending positions of the top rod 2130), so as to form a penetration 2136 between the leaning part 2135 and the connecting part 2131c for the top tether 2160 to pass through, so as to realize the connection between the top tether 2160 and the base 2120.

FIG. 19 is a schematic side view of the child safety seat according to the present disclosure, and shows that the top rod is away from the base and the upper top rod pivots with respect to the lower top rod to form an angle; and FIG. 20 is a schematic side view of the child safety seat according to the present disclosure, and shows that the top rod is close to the base and the upper top rod pivots with respect to the lower top rod to form an angle. As shown in FIGS. 19-20, the present disclosure solves the problem that the top rod 2130 affects the straightening of the top tether 2160 when the top tether 2160 of the child safety seat 2100 is connected with the top rod 2130. No matter what position the top rod 2130 is adjusted to (i.e., the top rod 2130 is away from the base 2120 or the top rod 2130 is close to the base 2120), due to the mutual pivoting of the upper top rod 2131 and the lower top rod 2132, not only the lower top rod 2132 may reliably lean against the seat back of the vehicle, and the top tether 2160 may be straightened after connecting the seat back of the vehicle and the seat body 2110 (the upper top rod 2131 and the lower top rod 2132 may pivot to each other to a desired angle, please referring to FIG. 16. For example, after the top tether 2160 connected to the seat body 2110 passes through the perforation 2136 and is connected to the vehicle seat, a force may be applied to the upper top rod 2131 so that the upper top rod 2131 pivot with respect to the lower top rod 2132 until the top tether 2160 is in a substantially straightened state, so as not to affect a state that the top tether 2160 is substantially straightened after passing through the penetration 2136 formed between the leaning part 2135 and the connecting part 2131c), so that the child safety seat 2100 may be connected to the vehicle seat more safely, and the possibility of overturning the child safety seat in an accident event can be avoided. In another embodiment, a length of the upper top rod 2131 may be changed (for example, the upper top rod 2131 is retractable). Further, after the length of the upper top rod 2131 is adjusted (for example, lengthened or shortened), the top tether 2160 may be substantially straightened in combination with the pivoting of the upper top rod 2131 with respect to the lower top rod 2132. That is, in this another embodiment, not only the upper top rod 2131 may pivot with respect to the lower top rod 2132, but also the length of the upper top rod 2131 may be adjusted. The pivoting of the upper top rod 2131 with respect to the lower top rod 2132 and the length adjustment of the upper top rod 2131 can be combined to ensure that the top tether 2160 shown in FIG. 19 is in a substantially straightened state.

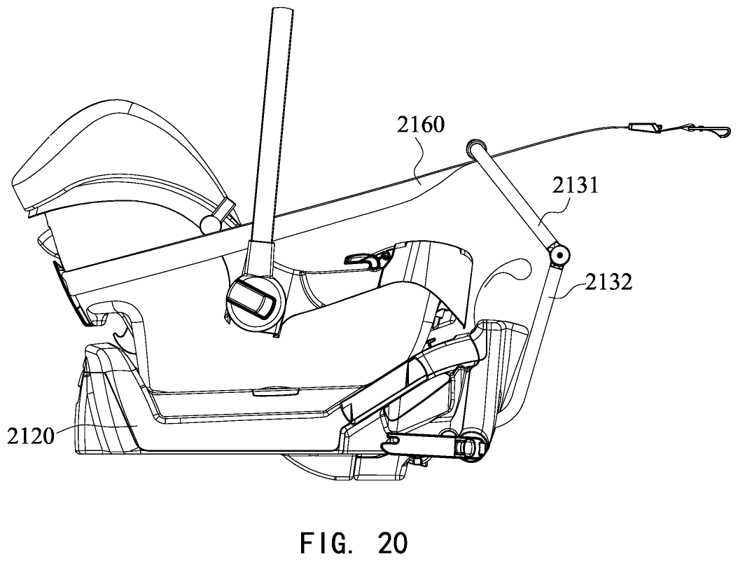

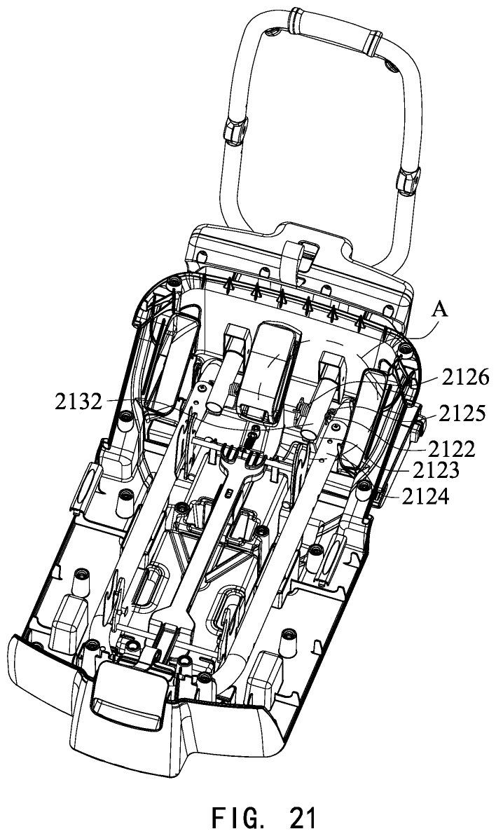

Referring to FIGS. 21-22, the lower top rod 2132 is pivotally installed to a connecting bracket 2123 through a pivoting shaft 2122, and the connecting bracket 2123 is installed to a base bracket longitudinal part 2124 of the base 2120. The connecting bracket 2123 may be a connecting iron piece. The fixing member 2125 is disposed on the pivoting shaft 2122, and passes through the penetration at one end of the pivoting shaft 2122 to limit the lower top rod 2132 to the pivot shaft 2122. In addition, a first torsion spring 2126 is provided between the pivoting shaft 2122 and the connecting bracket 2123, and the first torsion spring 2126 constantly biases the lower top rod 2132 in the direction close to the base 2120.

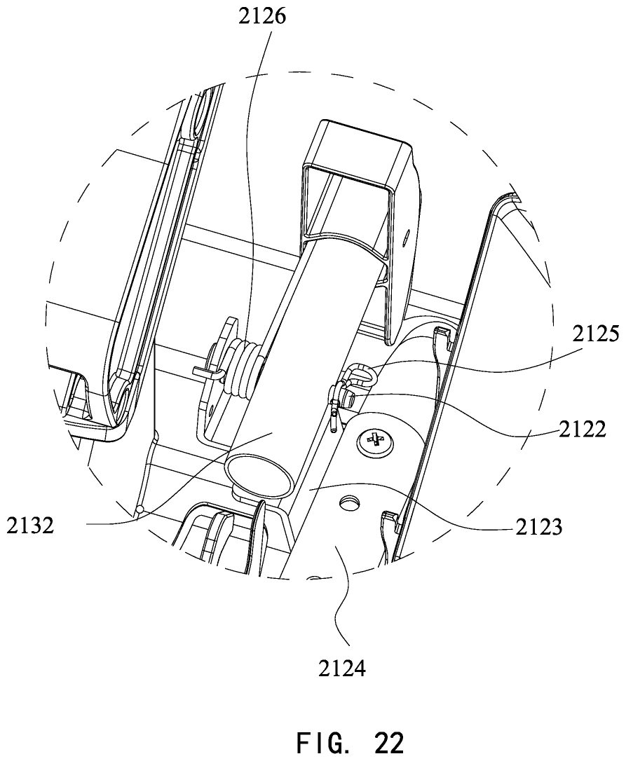

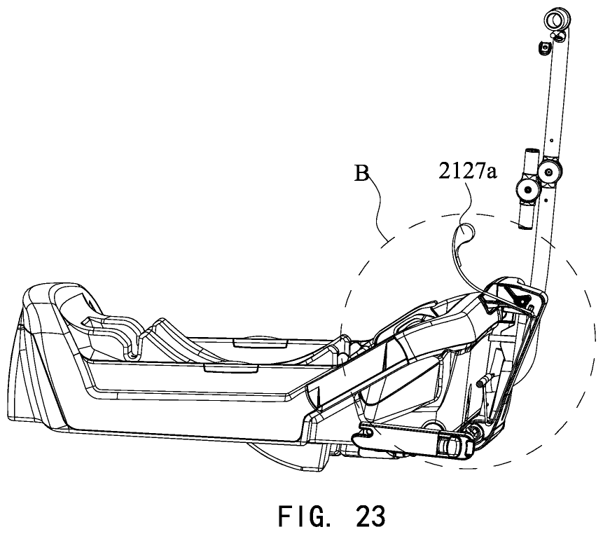

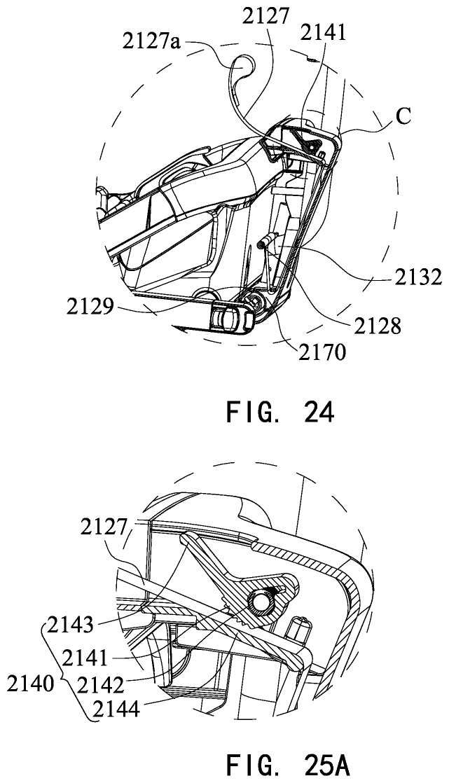

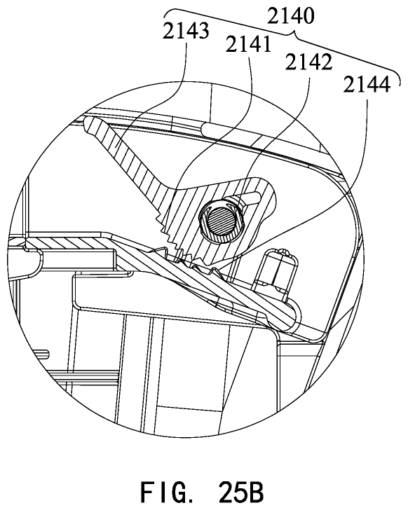

Referring to FIGS. 23-25B, FIG. 23 is a schematic side view of the base of the child safety seat according to the present disclosure and shows a partial cross-sectional view of the top rod structure; FIG. 24 is an enlarged schematic view of a framed area B in FIG. 23 and specifically shows a schematic view of the connection of the adjusting belt of the child safety seat with the base and the lower top rod according to the present disclosure; FIG. 25A is an enlarged schematic view of a framed area C in FIG. 24 and specifically shows a locking member of the child safety seat according to the present disclosure; and FIG. 25B is a schematic view according to FIG. 25A after the adjusting belt is omitted, and specifically shows a second locking part of the locking member of the child safety seat according to the present disclosure. As shown in FIGS. 23-25B, a lower end of the lower top rod 2132 is controlled to pivot with respect to the base 2120 through the adjusting belt 2127 disposed on the base 2120 and the locking member 2140, to correspondingly adjust the position of the top rod 2130.

Further, referring to FIGS. 23-25B, in one embodiment, one end of the adjusting belt 2127 is connected with the lower top rod 2132; and the other end of the adjusting belt 2127 winds around a winding part 2129 disposed on the base 2120 downwards and then extends upwards, passing through the locking member 2140 and extending out of the base 2120, thereby forming an operating end 2127a. By pulling the operating end 2127a, the lower top rod 2132 may pivot away from the base 2120. FIGS. 23-24 shows that the lower top rod 2132 is connected with a transverse rod 2128, one end of the adjusting belt 2127 is connected with the transverse rod 2128, and the winding part 2129 is a bracket connected to a base bracket transverse part 2170 of the base 2120, wherein the bracket may be a fixing iron piece. When it is necessary to pivot the lower top rod 2132 away from the base 2120, only the adjusting belt 2127 needs to be pulled, and the lower end of the adjusting belt 2127 will drive the transverse rod 2128 to push down the top rod 2132, so that the lower top rod 2132 may pivot in a clockwise direction, and the lower top rod 2132 may be locked away from the base 2120 by the locking member 2140.

Specifically, when the operating end 2127a is pulled, and under a tension of the adjusting belt 2127, the transverse rod 2128 will approach the fixing iron piece and press down the top rod 2132 as the winding part 2129 is connected to the bracket. Thus, as shown in FIGS. 15 and 16, the lower top rod 2132 may move downwards in a track 2150 of the base 2120 and pivot in a direction away from the base 2120. On the other hand, when the lower top rod 2132 pivots close to the base 2120, the locking member 2140 is unlocked, and under the action of the first torsion spring 2126, the lower top rod 2132 pivots in a direction close to the base 2120 (the lower top rod 2132 may move upwards in the track 2150 of the base 2120 and pivot in the direction close to the base 2120).

In another embodiment, the adjusting belt 2127 is a Y-shaped belt with three ends, two ends of the adjusting belt 2127 are connected with two lower top rods 2132, and the remaining end of the adjusting belt 2127 winds around the winding part 2129 disposed on the base 2120 downwards and then extends upwards, passing through the locking member 2140 and extending out of the base 2120, thereby forming an operating end 2127, so that by pulling the operating end 2127a, the lower top rod 2132 may move downwards in the track 2150 of the base 2120 and pivot in a direction away from the base 2120. That is, the transverse rod 2128 may be omitted in this another embodiment. The track 2150 is, for example, an elongated slot in the base 2120 for the lower top rod 2132 to move upwards and downwards in the elongated slot. Of course, the elongated slot may also limit a movement stroke of the lower top rod 2132.

FIGS. 23-25B show that the locking member 2140 is a tooth engagement mechanism. The tooth engagement mechanism includes an operating part 2143, a first locking part 2141, a second locking part 2144, and a second torsion spring 2142 that applies a torsion between the first locking part 2141 and the second locking part 2144. The adjusting belt 2127 passes between the first locking part 2141 and the second locking part 2144. The second torsion spring 2142 constantly presses the first locking part 2140 to be engaged with the second locking part 2144 to lock the adjusting belt 2127 between the first locking part 2141 and the second locking part 2144. For example, the first locking part 2141 is a toothed wheel and the second locking part 2144 is a rack. Through the above configuration, the user can pull the operating end 2127a of the adjusting belt 2127, so that the lower top rod 2132 may move downwards in the track 2150 of the base 2120 and pivot in a direction away from the base 2120. On the other hand, the operating part 2143 of the locking member 2140 may be operated by the user (such as applying an upward force) to make the first locking part 2141 in FIG. 25A rotate clockwise against the torsion of the second torsion spring 2142 to unlock the locking member 2140. The locking member 2140 may be unlocked by overcoming the torsion of the second torsion spring 2142, so that the lower top rod 2132 pivots in a direction close to the base 2120 under the action of the first torsion spring 2126 (shown in FIG. 22). That is, the locking member 2140 is unlocked by the operating part 2143, and a force applied to the operating part 2143 when unlocking is greater than a torsion of the second torsion spring 2142. A shape of the first locking part 2141 is matched with a shape of the second locking part 2144 to lock the adjusting belt 2127 between the first locking part 2141 and the second locking part 2144 (in FIGS. 23-25A, the second locking part 2144 is hidden by the adjusting belt 2127 thereon and not shown, and in FIG. 25B, the adjusting belt 2127 is omitted for clarity to show the second locking part 2144). The shapes of the first locking part 2141 and the second locking part 2144 are matched with each other, so that engaging directions of the first locking part 2141 and the second locking part 2144 are matched with each other, so that in the locking state, it is only allowed to pull the adjusting belt 2127, and when the user stops pulling the adjusting belt 2127, the first locking part 2140 is constantly pressed by the torsion of the second torsion spring 2142 to be engaged with the second locking part 2144 to lock the adjusting belt 2127 between the first locking part 2141 and the second locking part 2144.

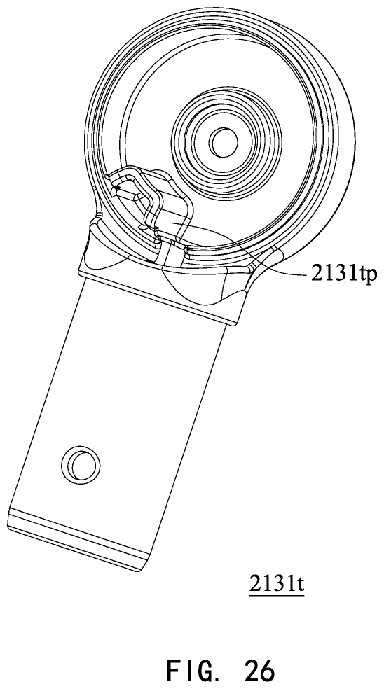

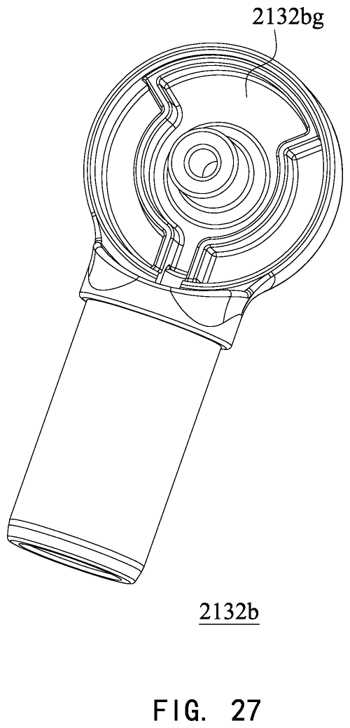

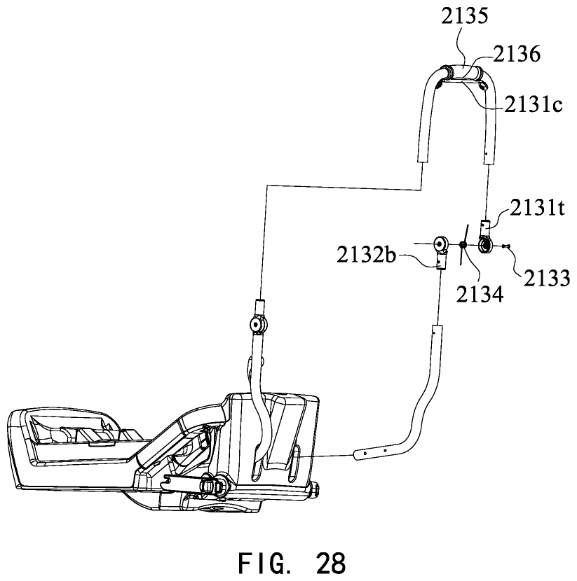

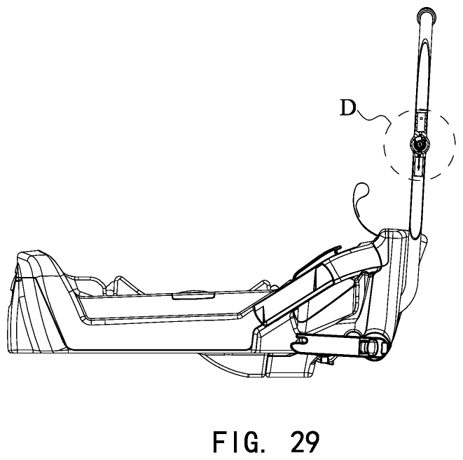

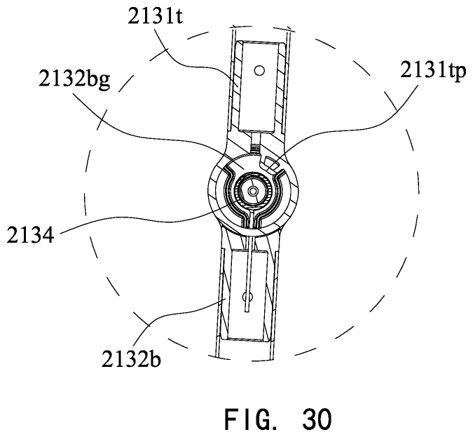

Referring to FIGS. 26-30, FIG. 26 is a perspective view of an upper top rod rotating seat 2131t of the child safety seat according to the present disclosure, FIG. 27 is a perspective view of a lower top rod rotating seat 2132b of the child safety seat according to the present disclosure, FIG. 28 is an exploded view of the top rod structure of the child safety seat according to the present disclosure, FIG. 29 is a schematic side view of the base of the child safety seat according to the present disclosure and shows a partial sectional view of the top rod structure, FIG. 30 is an enlarged schematic view of a framed area D in FIG. 29 and specifically shows the assembly relationship between the upper top rod rotating seat 2131t and the lower top rod rotating seat 2132b of the child safety seat according to the present disclosure. As shown in FIGS. 26-30, one end of the upper top rod 2131 towards the lower top rod 2132 is provided with an upper top rod rotating seat 2131t, and one end of the lower top rod 2132 towards the upper top rod 2131 is provided with a lower top rod rotating seat 2132b, and the upper top rod rotating seat 2131t is installed in cooperation with the lower top rod rotating seat 2132b to realize the mutual pivoting of the upper top rod 2131 and the lower top rod 2132.

FIGS. 26-27 shows that the upper top rod rotating seat 2131t is provided with a limiting protrusion 2131tp, and the lower top rod rotating seat 2132b is provided with a limiting groove 2132bg, and the limiting protrusion 2131tp cooperates with the limiting groove 2132bg to limit a rotation angle of the upper top rod 2131 with respect to the lower top rod 2132. Of course, the positions of the limiting protrusion 2131tp and the limiting groove 2132bg are interchangeable. That is, one of the upper top rod rotating seat 2131t and the lower top rod rotating seat 2132b is provided with the limiting protrusion 2131tp, and the other of the upper top rod rotating seat 2131t and the lower top rod rotating seat 2132b is provided with the limiting groove 2132bg. In one embodiment, the rotation angle of the upper top rod 2131 with respect to the lower top rod 2132 is 0-90 degrees. That is, the limiting groove 2132bg in FIG. 27 may limit a rotation range of the limiting protrusion 2131tp in the limiting groove 2132 bg from 0 to 90 degrees (when the rotation angle is 0, the upper top rod 2131 and the lower top rod 1212 are in the same line, and when the rotation angle is 90 degrees, the upper top rod 2131 pivotally moves towards the base 2120 with respect to the lower top rod 2132, and forms an angle of 90 degrees with the lower top rod 2132).

FIG. 28 shows that the upper top rod rotating seat 2131t and the lower top rod rotating seat 2132b are pivoted by a connecting shaft 2133. A third torsion spring 2134 is provided between the upper top rod rotating seat 2131t and the lower top rod rotating seat 2132b, and the third torsion spring 2134 constantly biases the upper top rod 2131 in a direction along the same straight line as the lower top rod 2132.

Referring to FIG. 30 again, a force may be applied to the upper top rod rotating seat 2131t to pivot the upper top rod rotating seat 2131t with respect to the lower top rod rotating seat 2132b, the limiting protrusion 2131tp moves in the limiting groove 2132bg, and the limiting protrusion 2131tp cooperates with the limiting groove 2132bg to limit the rotation angle of the upper top rod 2131 with respect to the lower top rod 2132. The third torsion spring 2134 between the upper top rod rotating seat 2131t and the lower top rod rotating seat 2132b constantly biases the upper top rod 2131 in a direction along the same straight line as the lower top rod 2132. As the third torsion spring 2134 constantly biases the upper top rod 2131 in the direction along the same straight line as the lower top rod 2132, the force applied to the upper top rod rotating seat 2131t is greater than the force applied by the third torsion spring 2134 to pivot the upper top rod rotating seat 2131t with respect to the lower top rod rotating seat 2132b.

The present disclosure also provides a child safety seat 2100. The child safety seat 2100 includes a seat body 2110 and a base 2120. The base 2120 is provided with the top rod structure of the present disclosure.

The present disclosure can be embodied in various forms without departing from the spirit and essence of the present disclosure, it should be understood that the above-mentioned embodiments are not limited to any of the foregoing details, but should be construed as broadly as possible within the scope defined by the claims, and therefore all changes that fall within the scope of the claims or their equivalents are intended to be covered by the claims.

1. An adjustment structure of a child safety seat, comprising:
a housing;
an abutting member at least partially disposed in the housing and movable with respect to the housing between a retracted position in which it extends into the housing and an extended position in which it extends out of the housing;
an adjusting member coupled with the abutting member and operable to move the abutting member to the extended position; and
a locking device coupled with the adjusting member and capable of locking the abutting member in the extended position.

2. The adjustment structure according to claim 1, wherein:
the adjusting member comprises an adjusting belt, and the adjusting belt comprises:
an operating end which extends out of the adjustment structure and is pullable, so that the adjusting belt is movable with respect to the housing; and
a connecting end connected to the abutting member, the connecting end driving the abutting member to move to the extended position when the operating end is pulled.

3. The adjustment structure according to claim 1, wherein:
the abutting member comprises:
a pivoting end pivotally connected to the housing;
a moving end which is opposite to the pivoting end and capable of extending into or out of the housing through pivoting of the abutting member with respect to the housing;
an abutting part located at an outer end of the moving end, the abutting part being an outermost part of the abutting part with respect to the housing when the abutting part is in the extended position; and
a connecting part located at the moving end and connected with the adjusting belt.

4. The adjustment structure according to claim 3, wherein:
the abutting member further comprises:
a limiting part located at the moving end and adjacent to the connecting part, and capable of limiting an extension range of the abutting member by abutting against an inner side of the housing.

5. (canceled)

6. The adjustment structure according to claim 2, wherein:
the locking device comprises:
an engaging seat disposed in the housing, the adjusting belt extending at least partially along the engaging seat;
an engaging member disposed in the housing, wherein the engaging member and the engaging seat are disposed on opposite sides of the adjusting belt,, and the engaging member is movable between a locking position and an unlocking position with respect to the housing,
when the engaging member is in the locking position, the engaging member prevents the adjusting belt from sliding on the engaging seat, and when the engaging member is in the unlocking position, the engaging member allows the adjusting belt to slide on the engaging seat.

7. The adjustment structure according to claim 6, wherein:
the engaging seat is provided with a sliding end and a sliding surface extending from the sliding end, and the adjusting belt is disposed on the sliding surface;
the connecting end of the adjusting belt is disposed below a back side of the sliding surface, and the adjusting belt sequentially winds around the sliding end from the connecting end, and is in sliding contact with the sliding surface, and then extends out of the adjustment structure, so that a part of the adjusting belt between the operating end and the sliding end forms a corner with respect to a part of the adjusting belt between the sliding end and the connecting end.

8. The adjustment structure according to claim 6, wherein:
the sliding surface of the engaging seat is provided with first clamping teeth;
the engaging member is provided with second engaging teeth at a position facing the adjusting belt, and when the engaging member is in the locking position, the first engaging teeth and the second engaging teeth cooperate with each other to lock the adjusting belt.

9. The adjustment structure according to claim 6, wherein:
the engaging member is pivotally disposed on the housing via a first pivot, and comprises a handle which is capable of being operated outside the housing to pivot the engaging member between the locking position and the unlocking position;
a first elastic member is disposed between the engaging member and the housing to bias the engaging member to the locking position.

10-12. (canceled)

13. A top rod structure disposed on a base of a child safety seat, that, wherein the top rod structure comprises:
a top rod comprising an upper top rod and a lower top rod which are pivoted with each other, the upper top rod being pivotable with respect to the lower top rod, and the lower top rod being configured to lean against one side of a vehicle seat back.

14-15. (canceled)

16. The top rod structure according to claim 13, wherein one end of the upper top rod facing the lower top rod is provided with an upper top rod rotating seat, one end of the lower top rod facing the upper top rod is provided with a lower top rod rotating seat, and the upper top rod rotating seat is installed in cooperation with the lower top rod rotating seat to realize a mutual pivoting of the upper top rod and the lower top rod.

17. The top rod structure according to claim 13, wherein one of the upper top rod rotating seat and the lower top rod rotating seat is provided with a limiting protrusion, and the other of the upper top rod rotating seat and the lower top rod rotating seat is provided with a limiting groove, and the limiting protrusion cooperates with the limiting groove to limit a rotation angle of the upper top rod with respect to the lower top rod.

18. The top rod structure according to claim 16, comprising:
a connecting shaft, wherein the upper top rod rotating seat and the lower top rod rotating seat are pivoted through the connecting shaft.

19-21. (canceled)

22. A child safety seat, comprising a body and the top rod structure according to claim 13, wherein the lower top rod is pivotally installed to the base to be away from or adjacent to the base.

23. (canceled)

24. The child safety seat according to claim 22, comprising:
an adjusting belt and a locking member disposed on the base, wherein a lower end of the lower top rod is controlled to pivot with respect to the base through the adjusting belt and the locking member.

25. The child safety seat according to claim 24, wherein the top rod structure comprises a pivoting shaft, the lower top rod is pivotally installed on a connecting bracket through the pivoting shaft, and the connecting bracket is connected to a base bracket longitudinal part of the base.

26-27. (canceled)

28. The child safety seat according to claim 24, wherein one end of the adjusting belt is connected with the lower top rod, and the other end of the adjusting belt winds around a winding part disposed on the base downwards and then extends upwards, passing through the locking member and extending out of the base to form an operating end, and a position of the top rod with respect to the base is adjustable by operating the operating end.

29. The child safety seat according to any one of claims claim 24, wherein the base comprises a track, and the track is disposed at a pivotal installation position of the lower top rod and the base, and the lower top rod is movable downwards or upwards in the track of the base and pivots in a direction away from or approaching to the base.

30. The child safety seat according to claim 24, wherein the adjusting belt is a Y-shaped belt with three ends, two ends of the adjusting belt are connected with the two lower top rods, and the remaining end of the adjusting belt winds around the winding part disposed on the base downwards and then extends upwards, passing through the locking member and extending out of the base to form an operating end, and the top rods is capable of being adjusted with respect to the base by operating the operating end.

31. (canceled)

32. The child safety seat according to claim 24, wherein the locking member comprises a first locking part, a second locking part, and a second torsion spring that applies a torsion between the first locking part and the second locking part, the adjusting belt passes between the first locking part and the second locking part, and the second torsion spring constantly presses the first locking part against the second locking part to lock the adjusting belt between the first locking part and the second locking part.

33. The child safety seat according to claim 32, wherein the locking member further comprises an operating part, and the locking member can be released through the operating part, wherein a releasing force applied to the operating part is greater than a torsion applied by the second torsion spring.

34-35. (canceled)
